(19) United States
(12) Patent Application Publication
(10) Pub. No.: US 2013/0329724 A1
(43) Pub. Date: Dec. 12, 2013

(54) TELEPHONE SYSTEM, SERVER APPARATUS AND CONTROL METHOD

(71) Applicant: Kabushiki Kaisha Toshiba, Tokyo (JP)

(72) Inventor: Seiichi YAMAMOTO, Sagamihara-shi (JP)

(73) Assignee: Kabushiki Kaisha Toshiba, Tokyo (JP)

(21) Appl. No.: 13/970,370

(22) Filed: Aug. 19, 2013

Related U.S. Application Data
(63) Continuation of application No. PCT/JP2013/057939, filed on Mar. 13, 2013.

(30) Foreign Application Priority Data
May 31, 2012 (JP) 2012-125129

(51) Int. Cl. H04M 7/00

(52) U.S. Cl. CPC H04M 7/0075
USPC 370/352

(57) ABSTRACT

According to one embodiment, a telephone system includes a plurality of communication terminals and a server apparatus. The server apparatus includes a memory, a determination module, and a controller. The memory stores in a management table terminal IDs in association with terminal type identifying information representing whether the communication terminals are SIP terminals or non-SIP terminals. The determination module determines whether or not a third communication terminal is an SIP terminal based on the management table. The controller causes a display of the third communication terminal to show the terminal ID of the second communication terminal as caller's information.

### CROSS REFERENCE TO RELATED APPLICATIONS

This application is a Continuation Application of PCT Application No. PCT/JP2013/057939, filed Mar. 13, 2013 and based upon and claiming the benefit of priority from Japanese Patent Application No. 2012-125129, filed May 31, 2012, the entire contents of all of which are incorporated herein by reference.

### FIELD

Embodiments described herein relate generally to a telephone system such as an Internet Protocol (IP) telephone system, a server apparatus used as a call management server, and a control method adapted for use in the server apparatus.

### BACKGROUND

In recent years, IP telephone systems are in widespread use. In an IP telephone system, an IP telephone terminal is connected to IP networks including a local area network (LAN) and the Internet. A call control server on an IP network enables sound communications between IP telephone terminals and between an IP telephone terminal and an ordinary telephone network. The Session Initiation Protocol (SIP) is widely used as the protocol of the IP telephone system.

In an IP telephone system, a single call control server enables using both an IP telephone terminal and an SIP telephone terminal. Even this type of IP telephone terminal provides a communications transfer service that complies with a request to transfer to a department connected to an attendant, as in a private branch exchange (PBX) and a key telephone apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block schematic view showing the IP telephone system according to the first embodiment.

FIG. 2 is a functional block diagram showing an example of a call control server shown in FIG. 1.

FIG. 3 shows an example of what is stored in an extension-call state management table shown in FIG. 2.

FIG. 4 is a sequence diagram illustrating how the first embodiment establishes a communication session between an IP telephone terminal serving as an organizer and an SIP telephone terminal serving as a terminal to which a call is transferred.

FIG. 5 is a sequence diagram illustrating how in the first embodiment, the user of the IP telephone terminal serving as the organizer puts the SIP telephone terminal, to which a call is transferred, on hold, and makes a call to the SIP telephone terminal, to which the call is transferred.

FIG. 6 is a sequence diagram illustrating how the first embodiment establishes the communication state between an SIP telephone terminal from which a call is transferred and an SIP telephone terminal to which the call is transferred.

FIG. 7 is a functional block diagram illustrating showing an example of a call control server according to the second embodiment.

FIG. 8 is a sequence diagram illustrating how the second embodiment switches the communication party of the SIP telephone terminal from the organizer to the transfer target, without causing undesired crossing after the enabling of the unscreened transfer function.

### DETAILED DESCRIPTION

Various embodiments will be described hereinafter with reference to the accompanying drawings. In general, according to one embodiment, a telephone system includes a plurality of communication terminals and a server apparatus. The plurality of communication terminals include an SIP terminal comprising a display. The server apparatus enables call connection between the communication terminals. the server apparatus includes a memory, a determination module, and a controller. The memory stores in a management table terminal IDs in association with terminal type identifying information representing whether the communication terminals are SIP terminals or non-SIP terminals, wherein the terminal IDs identifies communication terminals. The determination module refers to the management table based on a terminal ID of the transfer target included in information transmitted from a first communication terminal keeping the call to a second communication terminal, and determines whether or not a third communication terminal serving as the transfer target is an SIP terminal based on a result of reference, when transfer service is operated, wherein the transfer service referring to service the first communication terminal serving as an organizer, transfers a presently-incoming call to a transfer target, while keeping the call to the second communication terminal on hold, and disconnects the call to the second terminal before the transfer target makes a response in order to cause the second communication terminal to call the transfer target. The controller cancels the call which the second communication terminal makes to the third communication terminal when the determination module determines that the third communication terminal is an SIP terminal, sends a calling message to the third communication terminal thereafter, with the second communication terminal being displayed as a sender of the calling message, and causes a display of the third communication terminal to show the terminal ID of the second communication terminal as caller's information.

In an IP telephone system, a single call management server may have to manage both an IP telephone terminal and an SIP telephone terminal to reduce the expense needed for equipment. Even this type of IP telephone terminal can comply with communication transfer service by which a call is transferred to a desired department. The communication transfer service includes a call transfer, a screened transfer, and a blind transfer. In each transfer case, the organizer asks the caller to which department the call should be connected, calls the extension of the department, listens to a response from the user of the extension terminal, and then transfers the call to the extension of the department. This transfer method does not always provide desired processing efficiency, depending upon the time of the day.

In the present embodiment, the organizer uses the unscreened transfer function in order to eliminate the necessity of waiting for a response from the user of the extension terminal of the department requested by the caller and transferring the call after informing the user of the transfer target that the call is to be transferred. However, in the case where the terminal to which the call is transferred is an SIP terminal, the display of the SIP terminal shows the organizer as being the original caller. This may cause an inappropriate answer to the call.

In the present embodiment, the SIP terminal of the transfer target can display the telephone number of the original caller, thereby enabling an appropriate response, even when the unscreened transfer function is used.

### First Embodiment

The first embodiment displays the telephone number of a caller on the display of an SIP terminal, a transfer target, when the unscreened transfer function is used.

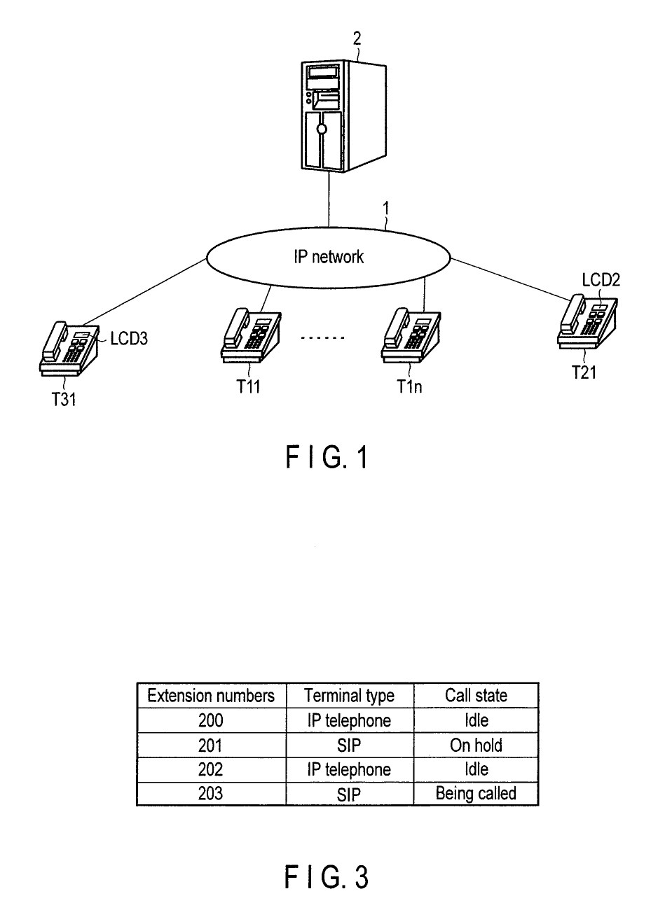

FIG. 1 is a block schematic view showing the IP telephone system according to the first embodiment.

The system of the first embodiment includes an Internet protocol (IP) network 1. A call control server 2, a plurality of IP telephone terminals T11 to T1n (n: a natural number) and SIP telephone terminals T21 and T31 having displays LCD2 and LCD3, are connected to the IP network 1. The IP telephone terminals T11 to T1n and the SIP terminals T21 and T31 are connected to the call control server 2 by way of the IP network 1.

The call control server 2 has the exchange control function of establishing a session based on, e.g., a session initiation protocol (SIP) between the IP telephone terminals T11 to T1n and the SIP terminals T21 and T31. After the session is established, RTP packets are exchanged between the telephone terminal of the caller and the telephone terminal of the callee on the peer-to-peer basis, for sound communications.

IP telephone terminal T11 is assigned with extension “200” as the terminal ID for identifying the terminal. IP telephone terminal T12 is assigned with extension “202.” SIP telephone terminal T21 is assigned with extension “201”, and SIP telephone terminal T21 is assigned with extension “203.”

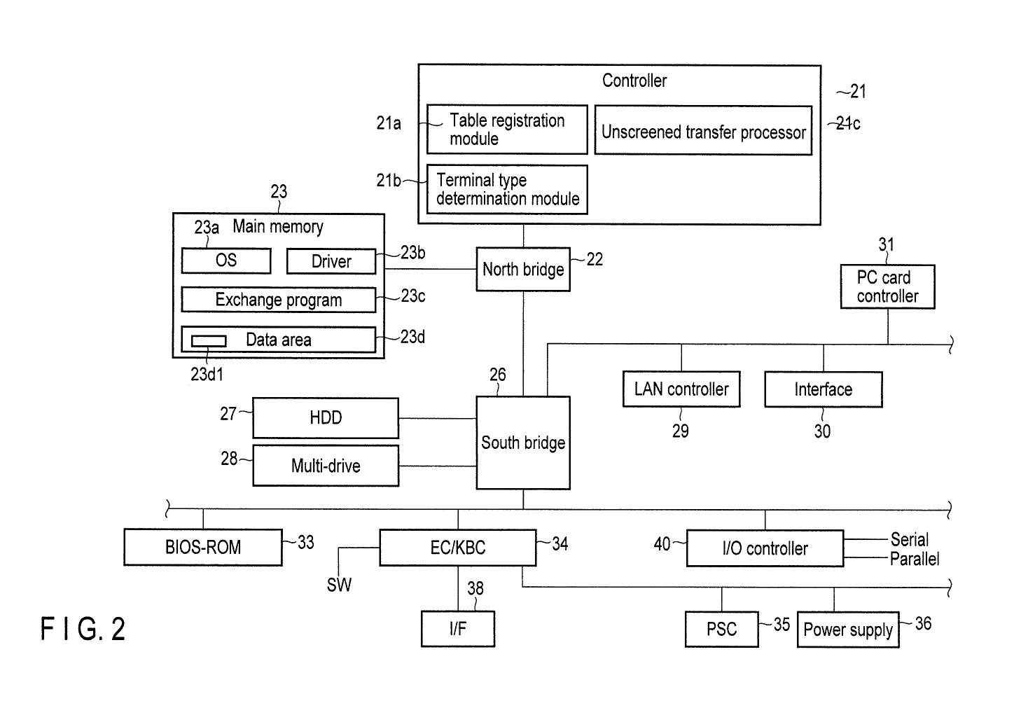

FIG. 2 is a functional block diagram showing an example of the call control server shown in FIG. 1.

The call control server 2 comprises: a controller 21, a north bridge 22, a main memory 23, a south bridge 26, a hard disk drive (HDD) 27, a multi-drive 28, a LAN controller 29, an interface 30, a PC card controller 31, a basis input/output system ROM 33, an embedded controller/keyboard controller (EC/KBC) 34, a power supply controller (PSC) 35, a power supply 36, an interface (I/F) 38, an I/O controller 40, etc.

The controller 21 is mainly made of a central processing unit (CPU) and controls the entire call control server 2. The controller 21 uses a main memory 23 as a work area and executes an operating system (OS) 23a, a driver 23b and an exchange program 23c, which are loaded in the main memory from the HDD 27.

The north bridge 22 comprises various control units, including a control unit for performing bridge processing between the controller 21 and the south bridge 26, and a control unit for controlling the main memory 23.

The south bridge 26 is connected to the north bridge 22 through a hub link and comprises the following: various devices on a low pin count (LPC) bus (such as EC/KBC 34 and I/O controller); various PCI devices on a peripheral component interconnect (PCI) bus (such as the LAN controller 29, the interface 30, and a PC card controller 31); a disk drive compatible with an integrated drive electronics (IDE); and various control units for controlling a USB device.

The HDD 27 is connected to the south bridge 26 as a device compatible with a primary IDE, and is a built-in hard disk for storing various programs (such as the OS and exchange programs) and various kinds of data. The multi-rive 28 is connected to the south bridge 26 as a device compatible with a secondary IDE and drives removable recording mediums such as a CD-ROM, a DVD-ROM and CD-R/RW.

The LAN controller 29 is connected to the south bridge 26 as a PCI device, has a communication function compatible with the specifications of a wired LAN, and is configured to communicate with a communication device having the same communication function.

The interface 30 is connected to the south bridge 26 as a PCI device, has a communication function compatible with the specifications of the IP network 1, and is configured to perform processing related to the exchange of RTP packets.

The PC card controller 31 is connected to the south bridge 26 as a PCI device, is compatible with the specifications of a personal computer memory card international association (PCMCIA), and is configured to control various types of PC cards. The BIOS-ROM 33 is connected to the LPC bus, and stores a basic input/output system (BIOS), which performs setting processing mainly for the hardware components of the call control server 2 when the power supply is turned on. The EC/KBC 34 is connected to the LPC bus and controls the power supply controller 35. The EC/KBC 34 is an integral combination of an embedded controller (EC) and a keyboard controller.

The power supply controller 35 is connected to the EC/KBC 34 through an I2C bus and controls the voltage applied to each component of the call control server 2. The power supply 36 generates driving power and applies it to the components of the call control server 2. The interface 38 permits connection of an input device and interfaces the signals supplied from the EC/KBC 34. The I/O controller 40 is connected to the LPC bus and performs input/output control of serial signals and parallel signals exchanged with an external device.

In the call control server 2, the exchange program 23c developed in the main memory 23 attains a predetermined exchange function under the control of the controller 21 and in cooperation with the LAN controller 29. The call control server 2 attains the exchange function between telephone terminals by loading the exchange program 23c in a general-purpose computer server and running the program. Like a general-purpose computer, the call control server 2 adopts a virtual memory system, by which data stored in physically discrete memory areas can be regarded as continuous data in the process of software.

The data area 23d of the main memory 23 stores an extension-call state management table 23d1. The extension-call state management table 23d1 is a table for managing the types of terminals and the presently-incoming call state (“idle”, “on hold” or “called”) for each of the extension numbers. As shown in FIG. 3, the extension-call state management table 23d1 stores data representing the relationships among the extension numbers, the types of terminals and the states of calls.

The controller 21 comprises a table registration module 21a, a terminal type determination module 21b, and an unscreened transfer processor 21c for SIP extensions. The table registration module 21a registers extension numbers “201” and “203” in the extension-call state management table 23d1 in response to REGISTER messages, which are transmitted from the SIP telephone terminals T21 and T31 at regular intervals. If, for example, SIP telephone terminal T21 does not transmit a REGISTER message at regular intervals, the table registration module 21a assumes that SIP telephone terminal T21 does not exist, so that SIP telephone terminal T21 is regarded as being incapable of communicating.

When, for example, IP telephone terminal T11 in the communication condition actuates the unscreened transfer function, the terminal type determination module 21b refers to the extension-call state management table 23d1 based on the extension number of the transfer target included in the information transmitted from IP telephone terminal T11, and determines based on the result of reference whether or not the transfer target is an “SIP telephone.”

When the terminal type determination module 21b determines that the transfer target is an “SIP telephone”, the unscreened transfer processor 21c for SIP extensions temporarily disconnects the call made from the transferee to the transfer target by “CANCEL”, and promptly transmits “INVITE” to the transfer target, with the transferee as an originating device, so that the display LCD3 of the SIP telephone terminal, which is the transfer target, displays the extension of the transferee as caller information.

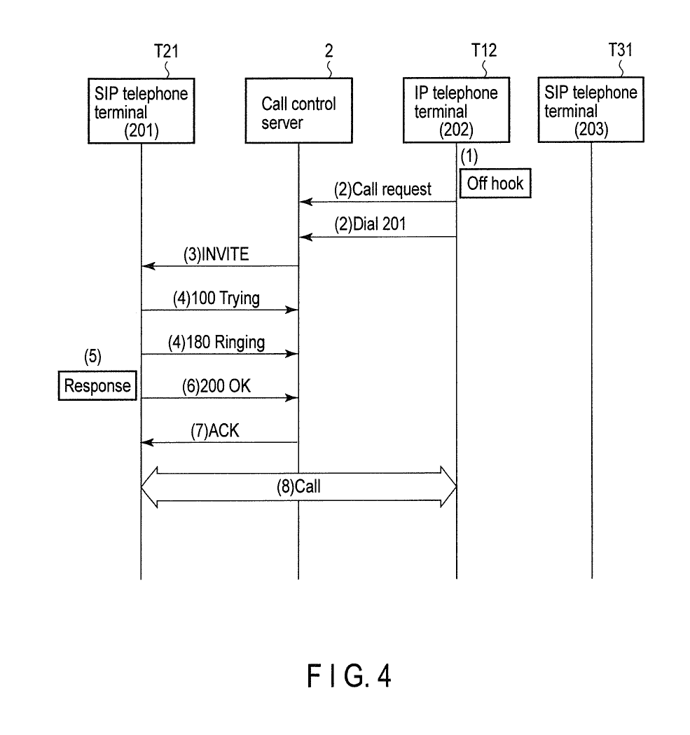

A description will now be given of the operation of the system having the configuration described above. The operation will be described based on the assumption of the cases set forth below. First, the user of IP telephone terminal T12 (extension 202) of the call control server 2 makes a call to the user of SIP telephone terminal T21. During the call, the user of SIP telephone terminal T21 asks the user of IP telephone terminal T12 for communications with the user of SIP telephone terminal T31, and the user of IP telephone terminal T12 makes a call to SIP telephone terminal T31 on behalf of the user of SIP telephone terminal T21. Roughly speaking, the operation proceeds as below, as shown in FIGS. 4-6.

(1) The user of IP telephone terminal T12 makes a call to SIP telephone terminal T21.

(2) The user of IP telephone terminal T12 puts SIP telephone terminal T21 on hold and makes a call to SIP telephone terminal T31.

(3) When SIP telephone terminal T31 responds, switching is performed to the call state between SIP telephone terminal T21 and SIP telephone terminal T31.

A detailed description of the operation will now be given.

(1) The user of IP telephone terminal T12 makes a call to SIP telephone terminal T21.

First, a description will be given of the operation for establishing a communication session between IP telephone terminal T12 and SIP telephone terminal T21. FIG. 4 is a sequence diagram illustrating how a communication session is established between IP telephone terminal T12 and SIP telephone terminal T21.

Let us assume that the user of IP telephone terminal T12 makes a call to SIP telephone terminal T21, as shown at (1) in FIG. 4. In response to this, a call request and dial “201” are transmitted from IP telephone terminal T12 to the call control server 2 ([2] of FIG. 4).

Upon receipt of the call request and dial “201”, the call control server 2 refers to the extension-call state management table 23d1, determines that the callee is an “SIP telephone”, and generates “INVITE” as defined by the SIP. The “INVITE” includes the extension number “202” of the caller. The call control server 2 transmits the “INVITE” to SIP telephone terminal T21, for calling ([3] of FIG. 4).

Upon receipt of the “INVITE”, SIP telephone terminal T21 returns “100 Trying” and “180 Ringing”, which indicate the execution of the call notification, to the call control server 2 ([4] of FIG. 4). The call notification is executed by ringing or displaying a called state.

When the user of SIP terminal T21 responds to the call notification ([5] of FIG. 4), SIP terminal T21 transmits a response message (200OK) to the call control server 2 ([6] of FIG. 4). Upon receipt of the response message (200OK), the call control server 2 sends ACK indicating the receipt of the response message (200OK) to SIP telephone terminal T21 ([7] of FIG. 4).

In this fashion, a communication session is established between IP telephone terminal T12, the caller, and SIP telephone terminal T21, the callee. RTP packets can be exchanged thereafter, and a telephone call is enabled ([8] of FIG. 4).

(2) The user of IP telephone terminal T12 puts SIP telephone terminal T21 on hold and makes a call to SIP telephone terminal T31.

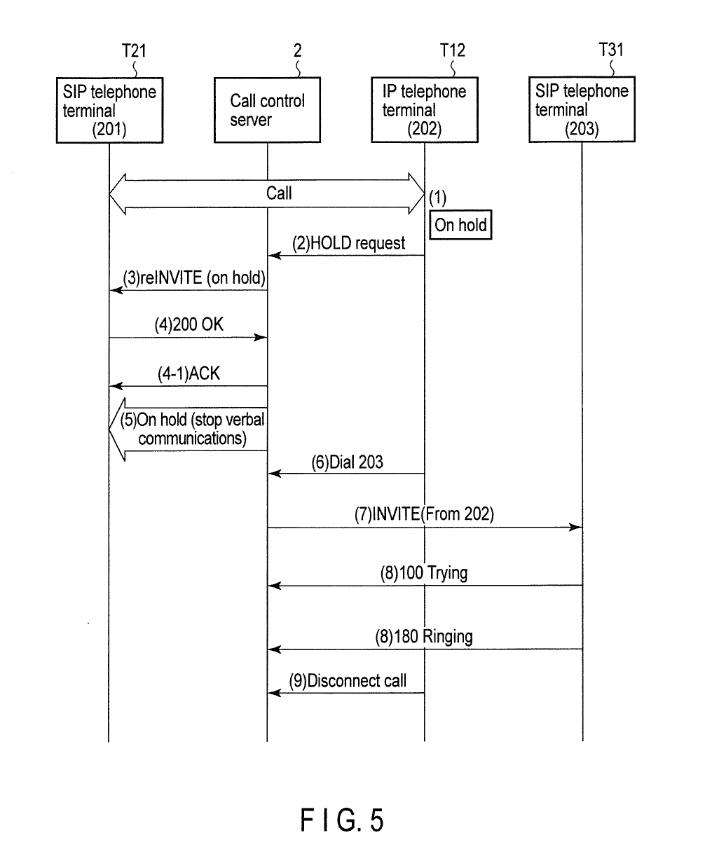

FIG. 5 is a sequence diagram illustrating how the user of IP telephone terminal T12 puts SIP telephone terminal T21 on hold and makes a call to SIP telephone terminal T31.

Let us assume that a call is established between IP telephone terminal T12 and SIP telephone terminal T21, as shown in FIG. 5, and the user of IP telephone terminal T12 depresses the hold key ([1] of FIG. 5). In response to the depression of the hold key, a hold request (HOLD) is transmitted from the IP telephone terminal T12 to the call control server 2 ([5] of FIG. 5).

Upon receipt of the hold request, the call control server 2 sends “re-INVITE” to SIP telephone terminal T21 ([3] of FIG. 5). Upon receipt of the “re-INVITE”, SIP telephone terminal T21 sends a response message (200OK) to the call control server 2 if a holding tone is audible ([4] of FIG. 5). Upon receipt of the response message (200OK) from SIP telephone terminal T21, the call control server 2 sends ACK indicating the receipt of the response message (200OK) to the SIP telephone terminal T21 ([4-1] of FIG. 5), and sends the holding tone to SIP telephone terminal T21 ([5] of FIG. 5).

Let us assume that the user dials extension “203” of the transfer target from IP telephone terminal T12 ([6] of FIG. 5). In response to “203” being dialed, the call control server 2 refers to the extension-call state management table 23d1, determines that the transfer target is an “SIP telephone”, and generates “INVITE” as defined by the SIP. The “INVITE” includes the extension number “202” of the caller. The call control server 2 transmits the “INVITE” to SIP telephone terminal T31, for calling ([7] of FIG. 5).

Upon receipt of the “INVITE”, SIP telephone terminal T31 returns “100 Trying” and “180 Ringing”, which indicate the execution of the call notification, to the call control server 2 ([8] of FIG. 5). The call notification is executed by ringing or displaying a called state.

If the user of IP telephone terminal T12 disconnects the call (“on hook”) before SIP terminal T31 responds to the call notification, a call disconnect request is sent to the call control server 2 ([9] of FIG. 5).

(3) When SIP telephone terminal T31 responds, switching is performed to the call state between SIP telephone terminal T21 and SIP telephone terminal T31.

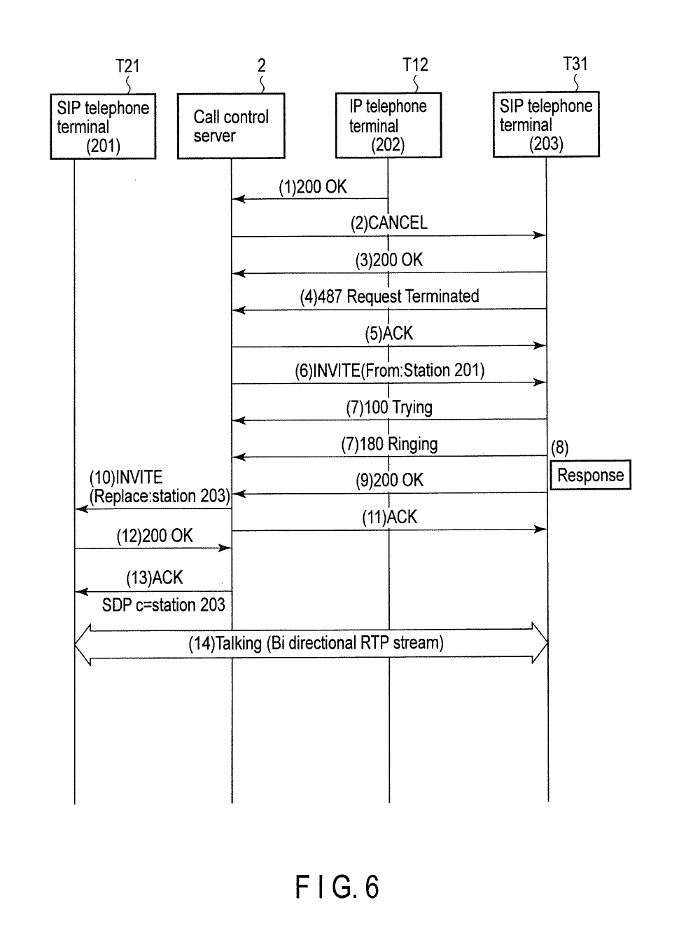

FIG. 6 is a sequence diagram illustrating how switching is performed to the call state between SIP telephone terminal T21 and SIP telephone terminal T31.

After a call disconnection request is transmitted, IP telephone terminal T12 sends 200OK to the call control server 2, thereby notifying the call control server 2 that the IP telephone terminal T12 has become idle ([1] of FIG. 6). At the time, the call control server 2 refers to the extension-call state management table 23d1, determines that the call state of the SIP telephone terminal T21 is “on hold” and the call state of SIP telephone terminal T31 is “called”, and transfers the call from SIP telephone terminal T21 to SIP telephone terminal T31. When it is determined that the transfer target is SIP telephone terminal T31, the call control server 2 also transmits “CANCEL” to SIP telephone terminal T31 with respect to the call that is being called ([2] of FIG. 6).

Upon receipt of the “CANCEL”, SIP telephone terminal T31 deletes the caller's extension number “202” from display LCD 3, sends 200OK indicating the acceptance of the “CANCEL” to the call control server 2 ([3] of FIG. 6), and sends “487 Request Terminated” to the call control server 2, thereby informing the call control server 2 that no malfunction occurs in SIP telephone terminal T31 ([4] of FIG. 6).

Upon receipt of “487 Request Terminated”, the call control server 2 sends a response (ACK) indicating the normal receipt of the “487 Request Terminated” to SIP telephone terminal T31 ([5] of FIG. 6), and generates “INVITE” anew. The “INVITE” includes the extension number “202” of the caller. The call control server 2 transmits the “INVITE” to SIP telephone terminal T31, for calling ([6] of FIG. 6).

Upon receipt of the “INVITE”, SIP telephone terminal T31 displays the caller's extension number “201” on the display LCD3, and returns “100 Trying” and “180 Ringing”, which indicate the execution of the call notification, to the call control server 2 ([7] of FIG. 6). The call notification is executed by ringing or displaying a called state.

When the user of SIP terminal T31 responds to the call notification ([8] of FIG. 6), SIP terminal T31 transmits a response message (200OK) to the call control server 2 ([9] of FIG. 6).

The call control server 2 transmits “INVITE”, including the extension number “202” of the caller, to SIP telephone terminal T21, which is a transferee, for calling ([10] of FIG. 6), and sends to SIP telephone terminal T31 “ACK” indicating the acceptance of a response message (200OK) ([11] of FIG. 6).

SIP telephone terminal T21 sends a response message (200OK) to the “INVITE” to the call control server 2 ([12] of FIG. 6). In response, the call control server 2 sends ACK, in which the SDP is set as extension number “203”, to SIP telephone terminal T21 ([13] of FIG. 6)

In this fashion, a communication session is established between IP telephone terminal T12 and IP telephone terminal T31. RTP packets can be exchanged thereafter, and a telephone call is enabled ([14] of FIG. 6).

Because of the features described above, the call notification to be displayed on the display LCD3 of SIP telephone terminal T31, the transfer target, is caller's information “201”, and it is possible to know the correct information of the caller before the call is answered.

As described above, in the first embodiment, the extension-call state management table 23d1, in which extension numbers and the types of terminals, such as “SIP telephone” and “IP telephone”, are associated with each other, is stored in the main memory 23 of the call control server 2. When IP telephone terminal T12, which is an organizer, enables an unscreened transfer function, the extension-call state management table 23d1 is referred to based on the extension number of the transfer target included in the information transmitted from IP telephone terminal T12. If the transfer target is SIP telephone terminal T31, the call is temporarily disabled by “CANCEL”, and another call is enabled by “INVITE”, including the extension number “202” of the transferee. The information on the transferee can be displayed on the display LCD3 of SIP telephone terminal T31, which is a transfer target.

Therefore, the unscreened transfer function, which is a feature of the existing exchange system, can be provided not only for IP telephone terminals but also for SIP telephone terminals, without any problems. The user can use the existing unscreened transfer function without reference to the types of telephone to which a call is transferred.

Furthermore, the first embodiment described above can display the extension number “202” of the transferee on the display LCD 3 of SIP telephone terminal T31, a transfer target, in place of the extension number “201” of the organizer, in synchronism with the unscreened transfer function being enabled. The user of the SIP telephone terminal T31 to which a call is transferred is allowed to know the call transfer before taking the call.

### Second Embodiment

The second embodiment is intended to reject calling an SIP terminal as a transfer target when the unscreened transfer function is enabled and “INVITE” is received from the SIP terminal serving as the transfer target.

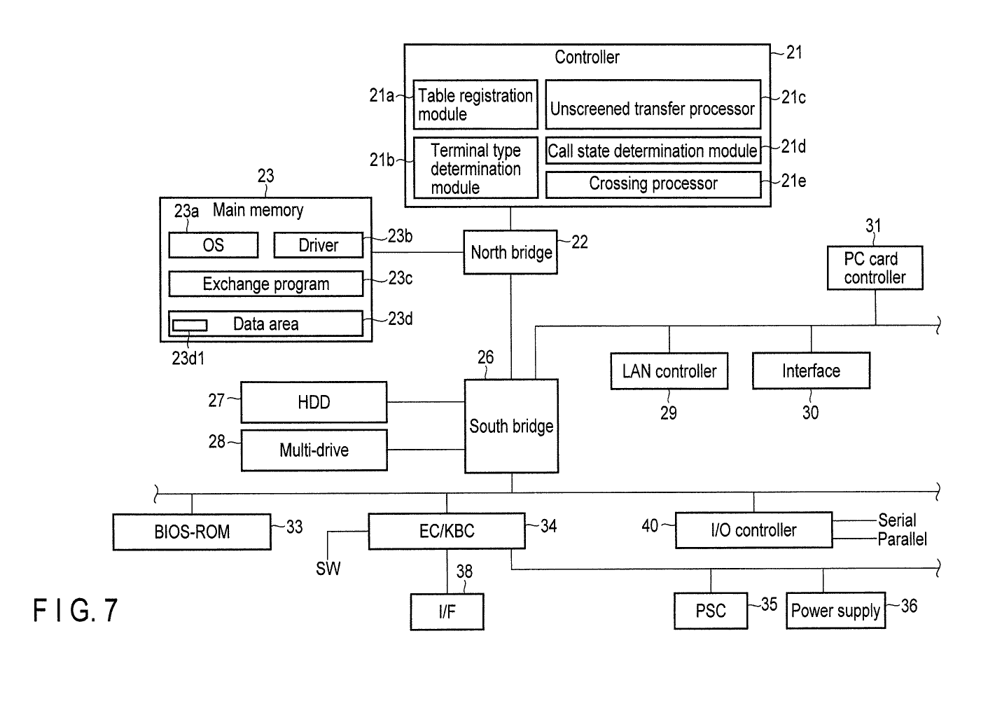

FIG. 7 is a functional block diagram illustrating showing an example of a call control server 2 according to the second embodiment. The controller 21 of the second embodiment further comprises a call state determination module 21d and a crossing processor 21e. If a call from a transferee to a transfer target is disconnected by “CANCEL” and thereafter “INVITE” is sent from the transfer target, the call state determination module 21d refers to the call state information which the extension-call state management table 23d1 stores as corresponding to the transfer target, and determines whether or not the call state information is “being called.”

If the call state determination module 21d determines that the state is “being called”, the crossing processor 21e transmits “480 Temporarily Unavailable” to the transfer target and rejects the call transfer.

A description will now be given of the operation of the system having the above configuration.

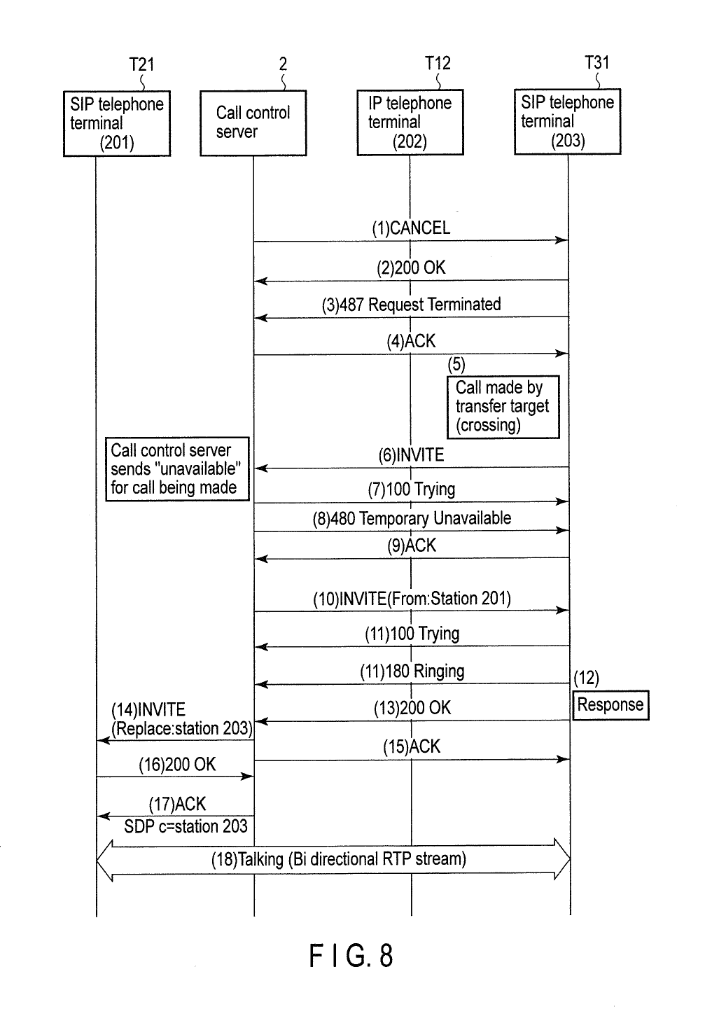

FIG. 8 is a sequence diagram illustrating how the communication party of the SIP telephone terminal T21 is switched from IP telephone terminal T12 to SIP telephone terminal T31, without causing undesired crossing after the enabling of the unscreened transfer function.

When IP telephone terminal T12, serving as an organizer, enables the unscreened transfer, the call control server 2 refers to the extension-call state management table 23d1, determines that the call state of SIP telephone terminal T21 is “on hold” and the call state of SIP telephone terminal t31 is “being called”, and transfers a call from SIP telephone terminal T21 to SIP telephone terminal T31. If the call control server 2 determines that the transfer target is SIP telephone terminal T31, the call control server 2 transmits “CANCEL” to SIP telephone terminal T31 with respect to the call being made ([1] of FIG. 8).

Upon receipt of the “CANCEL”, the SIP telephone terminal T31 deletes the organizer's (caller's) extension number “202” from the display LCD 3, sends 200OK indicating the acceptance of the “CANCEL” to the call control server 2 ([2] of FIG. 8), and sends “487 Request Terminated” to the call control server 2, thereby informing the call control server 2 that no malfunction occurs in SIP telephone terminal T31 ([3] of FIG. 8).

Upon receipt of “487 Request Terminated”, the call control server 2 sends a response (ACK) indicating the normal receipt of the “487 Request Terminated” to SIP telephone terminal T31 ([4] of FIG. 8).

Let us assume that the user of SIP telephone terminal T31 makes a call to IP telephone terminal T14 after the transmission of the ACK ([5] of FIG. 8). In response to this operation, SIP telephone terminal T31 sends “INVITE” to the call control server 2 ([6] of FIG. 8).

The call control server 2 sends “100 Trying”, which indicates the reception of “INVITE”, to SIP telephone terminal T31 ([7] of FIG. 8), refers to the call state information which the extension-call state management table 23d1 stores as corresponding to the transfer target, and determines whether or not the call state information is “being called.” If it is determined that the state is “being called”, “480 Temporarily Unavailable” is transmitted to SIP telephone terminal, the transfer target, and the call transfer is rejected ([8] of FIG. 8).

Upon receipt of “487 Request Terminated” ([9] of FIG. 8), the call control server 2 generates “INVITE” anew. The “INVITE” includes the extension number “201” of the caller. The call control server 2 transmits the “INVITE” to SIP telephone terminal T31, for calling ([10] of FIG. 8).

Upon receipt of the “INVITE”, SIP telephone terminal T31 displays the caller's extension number “201” on the display LCD3, and returns “100 Trying” and “180 Ringing”, which indicate the execution of the call notification, to the call control server 2 ([11] of FIG. 8). The call notification is executed by ringing or displaying a called state.

When the user of SIP terminal T31 responds to the call notification ([12] of FIG. 8), SIP terminal T31 transmits a response message (200OK) to the call control server 2 ([13] of FIG. 8).

The call control server 2 transmits “INVITE”, including the extension number “203” of the caller, to SIP telephone terminal T21, which is a transferee, for calling ([14] of FIG. 8), and sends to SIP telephone terminal T31 “ACK” indicating the acceptance of a response message (200OK) ([15] of FIG. 8).

SIP telephone terminal T21 sends a response message (200OK) to the “INVITE” to the call control server 2 ([16] of FIG. 8). In response, the call control server 2 sends ACK, in which the SDP is set as extension number “203”, to SIP telephone terminal T21 ([17] of FIG. 8)

In this fashion, a communication session is established between IP telephone terminal T21 and IP telephone terminal T31. RTP packets can be exchanged thereafter, and a telephone call is enabled ([18] of FIG. 8).

The timing at which “INVITE” (Replace) is transmitted to the transferee is not limited to that described in connection with the second embodiment.

As described above, in the second embodiment, the extension-call state management table 23d1 is stored in the main memory 23 when the unscreened transfer function is enabled. If a call transferred from the transferee to the transfer target is disconnected by “CANCEL” and “INVITE” sent from the transfer target crosses the “CANCEL”, the call state information which the extension-call state management table 23d1 stores as corresponding to the transfer target is referred to, whereby it is recognized that SIP telephone terminal T31, the transfer target, is being called. In this manner, the call from SIP telephone terminal T31 is rejected, and undesirable crossing is prevented.

### Other Embodiments

In the embodiments described above, reference was made to the case where the communication terminals were IP telephone terminals and SIP telephone terminals. Needless to say, the communication terminals may be other than those telephone terminals.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A telephone system comprising:
a plurality of communication terminals that include an SIP terminal comprising a display; and
a server apparatus configured to enable call connection between the communication terminals,
wherein the server apparatus comprising:
a memory configured to store in a management table terminal IDs in association with terminal type identifying information representing whether the communication terminals are SIP terminals or non-SIP terminals, wherein the terminal IDs identifies communication terminals;
a determination module configured to refer to the management table based on a terminal ID of the transfer target included in information transmitted from a first communication terminal keeping the call to a second communication terminal, and to determine whether or not a third communication terminal serving as the transfer target is an SIP terminal based on a result of reference, when transfer service is operated, wherein the transfer service referring to service the first communication terminal serving as an organizer, transfers a presently-incoming call to a transfer target, while keeping the call to the second communication terminal on hold, and disconnects the call to the second terminal before the transfer target makes a response in order to cause the second communication terminal to call the transfer target; and
a controller configured to cancel the call which the second communication terminal makes to the third communication terminal when the determination module determines that the third communication terminal is an SIP terminal, to send a calling message to the third communication terminal thereafter, with the second communication terminal being displayed as a sender of the calling message, and to cause a display of the third communication terminal to show the terminal ID of the second communication terminal as caller's information.

2. The telephone system of claim 1, wherein:
when the transfer service is enabled, the memory is further configured to store call state information, representing a state of being called, in association with a terminal ID of the third communication terminal included in the management table; and
the controller comprises a processor configured to operate when the call which the second communication terminal makes to the third communication terminal is canceled, and the calling message is thereafter sent from the third communication terminal, to refer to call state information included in the management table and corresponding to the third communication terminal, and to reject the call made from the third communication terminal if the call state information represents a state of being called.

3. The telephone system of claim 1, wherein the controller is further configured to cause the display of the third communication terminal to show a terminal ID of the first communication terminal as the caller's information during a period starting from a time when the transfer service is enabled and to a time when the second communication terminal disconnects the call made to the third communication terminal, and to send a calling message originating from the second communication terminal to the third communication terminal from a time when the call is disconnected, such that the third communication terminal shows the terminal ID of the second communication terminal in place of the terminal ID of the first communication terminal.

4. The telephone system of claim 1, wherein the controller is further configured to disconnect the call made from the second communication terminal to the third communication terminal by “CANCEL”, and to thereafter transmit “INVITE” originating from the second communication terminal to the third communication terminal.

5. The telephone system of claim 2, wherein the processor is further configured to refer to call state information included in the management table and corresponding to the third communication terminal, and to transmit “480 Temporarily Unavailable” to the third communication terminal in order to reject the call made from the third communication terminal if the call state information represents a state of being called, when the call which the second communication terminal makes to the third communication terminal is canceled, and the calling message is thereafter sent from the third communication terminal.

6. A server apparatus that enables call connection between a plurality of communication terminals that include an SIP terminal comprising a display, the server apparatus comprising:
a memory configured to store in a management table terminal IDs in association with terminal type identifying information representing whether the communication terminals are SIP terminals or non-SIP terminals, wherein the terminal IDs identifies communication terminals;
a determination module configured to refer to the management table based on a terminal ID of the transfer target included in information transmitted from a first communication terminal keeping the call to a second communication terminal, and to determine whether or not a third communication terminal serving as the transfer target is an SIP terminal based on a result of reference, when transfer service is operated, wherein the transfer service referring to service the first communication terminal serving as an organizer, transfers a presently-incoming call to a transfer target, while keeping the call to the second communication terminal on hold, and disconnects the call to the second terminal before the transfer target makes a response in order to cause the second communication terminal to call the transfer target; and
a controller configured to cancel the call which the second communication terminal makes to the third communication terminal when the determination module determines that the third communication terminal is an SIP terminal, to send a calling message to the third communication terminal thereafter, with the second communication terminal being displayed as a sender of the calling message, and to cause a display of the third communication terminal to show the terminal ID of the second communication terminal as caller's information.

7. The server apparatus of claim 6, wherein:
when the transfer service is enabled, the memory is further configured to store call state information, representing a state of being called, in association with a terminal ID of the third communication terminal included in the management table; and
the controller comprises a processor configured to operate when the call which the second communication terminal makes to the third communication terminal is canceled, and the calling message is thereafter sent from the third communication terminal, to refer to call state information included in the management table and corresponding to the third communication terminal, and to reject the call made from the third communication terminal if the call state information represents a state of being called.

8. The server apparatus of claim 6, wherein the controller is further configured to cause the display of the third communication terminal to show a terminal ID of the first communication terminal as the caller's information during a period starting from a time when the transfer service is enabled and to a time when the second communication terminal disconnects the call made to the third communication terminal, and to send a calling message originating from the second communication terminal to the third communication terminal from a time when the call is disconnected, such that the third communication terminal shows the terminal ID of the second communication terminal in place of the terminal ID of the first communication terminal.

9. The server apparatus of claim 6, wherein the controller is further configured to disconnect the call made from the second communication terminal to the third communication terminal by “CANCEL”, and to thereafter transmit “INVITE” originating from the second communication terminal to the third communication terminal.

10. The server apparatus of claim 7, wherein the processor is further configured to refer to call state information included in the management table and corresponding to the third communication terminal, and to transmit “480 Temporarily Unavailable” to the third communication terminal in order to reject the call made from the third communication terminal if the call state information represents a state of being called, when the call which the second communication terminal makes to the third communication terminal is canceled, and the calling message is thereafter sent from the third communication terminal.

11. A control method for use in a server apparatus configured to enable call connection between a plurality of communication terminals that include an SIP terminal comprising a display, the method comprising:
storing a management table in which terminal IDs identifying communication terminals are associated with terminal type identifying information representing whether the communication terminals are SIP terminals or non-SIP terminals;
when transfer service is enabled wherein a first communication terminal, included in a plurality of communication terminals and serving as an organizer, transfers a presently-incoming call to a transfer target, while keeping the call to a second communication terminal, included in the communication terminals, on hold, and disconnects the call to the second terminal before the transfer target makes a response in order to cause the second communication terminal to call the transfer target, referring to the management table based on a terminal ID of the transfer target included in information transmitted from the first communication terminal, and determining whether or not the third communication terminal serving as the transfer target is an SIP terminal based on a result of reference; and
cancelling the call which the second communication terminal makes to the third communication terminal when the determining determines that the third communication terminal is an SIP terminal, sending a calling message to the third communication terminal thereafter, with the second communication terminal being displayed as a sender of the calling message, and causing a display of the third communication terminal to show the terminal ID of the second communication terminal as caller's information.

12. The control method of claim 11, wherein:
when the transfer service is enabled, the storing comprises storing call state information, representing a state of being called, in association with a terminal ID of the third communication terminal included in the management table; and
when the call which the second communication terminal makes to the third communication terminal is canceled, and the calling message is thereafter sent from the third communication terminal, the control is performed by referring to call state information included in the management table and corresponding to the third communication terminal, and rejecting the call made from the third communication terminal if the call state information represents a state of being called.

13. The control method of claim 11, wherein the control is performed by: causing the display of the third communication terminal to show a terminal ID of the first communication terminal as the caller's information during a period starting from a time when the transfer service is enabled and to a time when the second communication terminal disconnects the call made to the third communication terminal, and sending a calling message originating from the second communication terminal to the third communication terminal from a time when the call is disconnected, such that the third communication terminal shows the terminal ID of the second communication terminal in place of the terminal ID of the first communication terminal.

14. The control method of claim 11, wherein the control is performed by disconnecting the call made from the second communication terminal to the third communication terminal by “CANCEL”, and thereafter transmitting “INVITE” originating from the second communication terminal to the third communication terminal.

15. The control method of claim 12, wherein when the call which the second communication terminal makes to the third communication terminal is canceled, and the calling message is thereafter sent from the third communication terminal, the control is performed by referring to call state information included in the management table and corresponding to the third communication terminal, and transmitting “480 Temporarily Unavailable” to the third communication terminal in order to reject the call made from the third communication terminal if the call state information represents a state of being called.
